(19) United States
(12) Patent Application Publication
(10) Pub. No.: US 2021/0231455 A1
(43) Pub. Date: Jul. 29, 2021

(54) AUGMENTED REALITY SYSTEM AND METHOD FOR MOBILE DEVICE DISCOVERY WITH INDOOR AND OUTDOOR NAVIGATION

(71) Applicant: Toshiba TEC Kabushiki Kaisha, Shinagawa-ku (JP)

(72) Inventors: Amy NGUYEN, Santa Ana, CA (US); William TANG, Covina, CA (US)

(21) Appl. No.: 16/750,622

(22) Filed: Jan. 23, 2020

(51) Int. Cl. G01C 21/36; G01C 21/20; H04W 4/024; H04W 4/33; H04W 4/029; G06K 9/00

(52) U.S. Cl. CPC G01C 21/3644; G01C 21/3664; G01C 21/206; G06K 9/00671; H04W 4/33; H04W 4/029; H04W 4/024

(57) ABSTRACT

An augmented reality system and method for mobile device discovery with indoor and outdoor navigation includes a user device with a processor, memory, a touchscreen user interface and a wireless data interface. The processor generates a map display on the touchscreen including indicia illustrating a position of each of a plurality of MFPs on an associated premises. The processor receives a user selection of an indicia via the touchscreen and displays data corresponding to a status of a selected MFP associated with the user selected indicia. The processor receives a second user selection associated with the user selected indicia via the touchscreen and displays navigation data corresponding to navigation to the selected MFP.

### TECHNICAL FIELD

This application relates generally to printing. The application relates more particularly to assisted printing and retrieval of printed documents at various printing locations disposed about a premises.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Often times MFPs that are available for users are disposed about a premises, such a college or business campus. One or more MFPs may be located on one or more floors of one or more buildings dispersed about a campus. An employee or student may wish to print a document via a portable data device, such as a smartphone, tablet or notebook computer. However, they may not be aware of available MFPs or their location.

### BRIEF DESCRIPTION OF THE DRAWINGS

Various embodiments will become better understood with regard to the following description, appended claims and accompanying drawings wherein:

FIG. 1 is an example embodiment of a system for MFP device discovery for a mobile device;

FIG. 2 is an example embodiment of a networked digital device comprised of document rendering system;

FIG. 3 is an example embodiment of a portable digital device such as a tablet, notebook or smartphone;

FIG. 4 is an example embodiment of an MFP location system;

FIG. 5 is an example embodiment of an MFP device discovery touchscreen interface;

FIG. 6 is an example embodiment of a user device interface when the user navigates to and enters their selected building;

FIG. 7 is an example embodiment of a user device interface screen showing a routing overview and time estimation from the user's current location to a selected location;

FIG. 8 is an example embodiment of a device interface showing a suitable outdoor navigation;

FIG. 9 is an example embodiment of a use environment of an indoor navigation view or user device/interface; and

FIG. 10 is an example embodiment of an augmented reality system for mobile device discovery with indoor and outdoor navigation.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In accordance with an example embodiment disclosed herein, a user device includes a processor, memory, a touchscreen user interface and a wireless data interface. The processor generates a map display on the touchscreen including indicia illustrating a position of each of a plurality of MFPs on an associated premises. The processor receives a user selection of an indica via the touchscreen and displays data corresponding to a status of a selected MFP associated with a user selected indicia. The processor receives a second user selection associated with the user selected indicia via the touchscreen and displays navigation data corresponding to navigation to the selected MFP.

With the high demand for printing service in an education and business environment, there is a need for speed, efficiency, quick turn-around time and seamless interface.

The introduction of mobile devices and printing applications in education and enterprise environment have benefited the students and office employees significantly in their daily tasks. End users of mobile applications are now equipped to perform functional operations to the MFP that are visible and available to them.

When a typical university student or an office employee tries to locate an available MFP, it may be disposed on a particular floor inside a multiple story building. Example embodiments described herein use the Global Position System (GPS). However, GPS is largely constrained to outdoor navigation. GPS signals do not work with indoors infrastructure and they tend to attenuate and scatter by roofs and walls. MFPs are typically located indoors and are frequently in multiple story buildings. Embodiments herein employ tools such as Google Maps and a suitable third party indoor navigation system along with device discovery to provide seamless document printing with real time device status updates and rich location data navigation. Suitable navigation systems include the Google Map SDK and indoor navigation via applications such as SDKs from INFSOFT or NavVis.

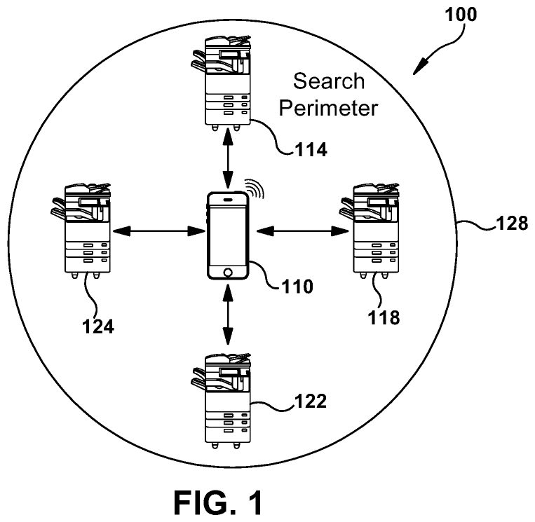

In accordance with the subject application, FIG. 1 illustrates an example embodiment of a system 100 for MFP device discovery for a mobile device such as smartphone 110. An embedded mobile application provides a user a multidimensional navigation experience that seamlessly discovers available devices and guides the user to the closest available MFP at a targeted location within an identified building infrastructure. Available MFPs, such as MFPs 114, 118, 122 and 124 are identified from a network discovery within a specified search perimeter 128. A suitable search perimeter may be identification of MFPs that are on the same domain as the user device. A list of the MFPs that are on the network is obtained. Locations of each MFP are suitably obtained through cross referencing of beacon information from beacons associated with the MFPs in a suitable database as will detailed further below.

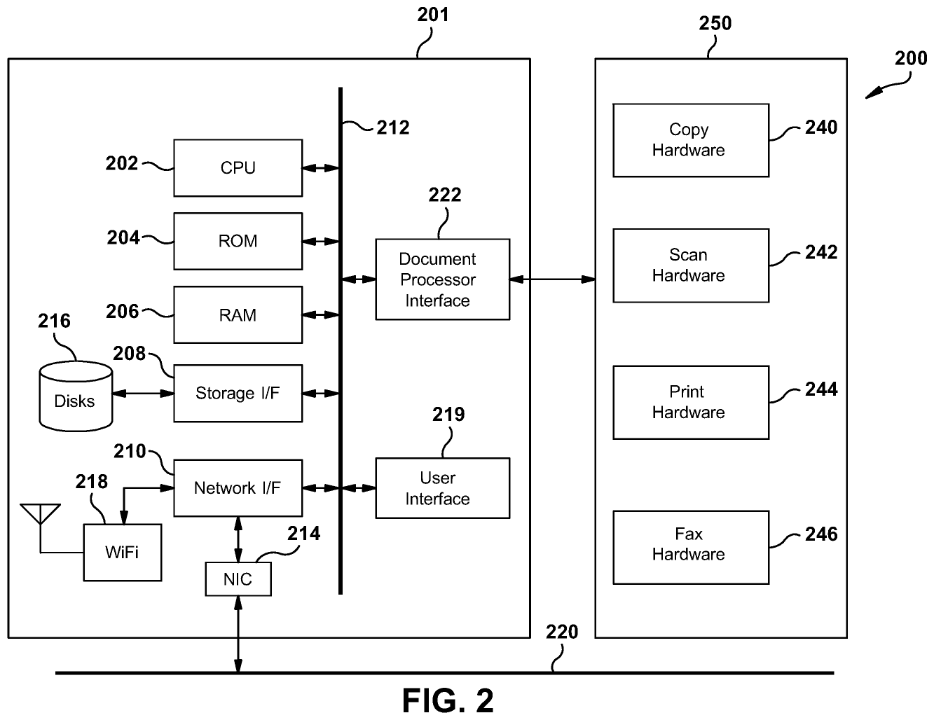

Turning now to FIG. 2 illustrated is an example embodiment of a networked digital device comprised of document rendering system 200 suitably comprised within an MFP, such as with MFPs 114, 118, 122 or 124 of FIG. 1. It will be appreciated that an MFP includes an intelligent controller 201 which is itself a computer system. Thus, an MFP can itself function as a cloud server with the capabilities described herein. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

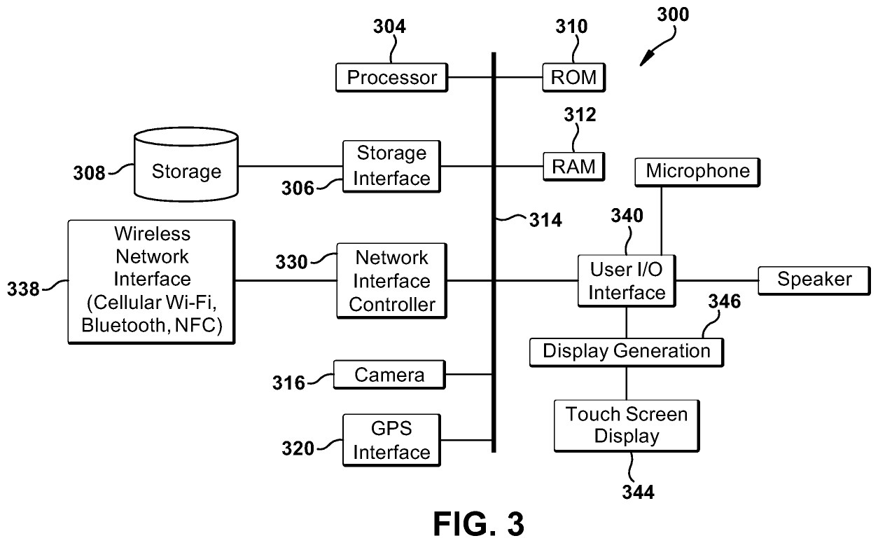

Turning now to FIG. 3, illustrated is an example of a portable digital device 300 suitably comprising a tablet, notebook or smartphone such as smartphone 111 of FIG. 1. Included are one or more processors, such as that illustrated by processor 304. Each processor is suitably associated with non-volatile memory, such as read only memory (ROM) 310 and random access memory (RAM) 312, via a data bus 314. Also in data communication with data bus 314 is digital camera 316 and GPS interface 320.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an MFP or server is via a data network, such as a local area network (LAN), a wide area network (WAN), which may comprise the Internet, or any suitable combination thereof. A digital data connection is also suitably directly with an MFP or server, such as via Bluetooth, optical data transfer, Wi-Fi direct, NFC or the like.

Processor 304 is also in data communication with a user input/output (I/O) interface 340 which provides data communication with user peripherals, such as touch screen display 344 via display generator 346, as well as keyboards, mice, track balls, touch screens, or the like. It will be understood that functional units are suitably comprised of intelligent units, including any suitable hardware or software platform.

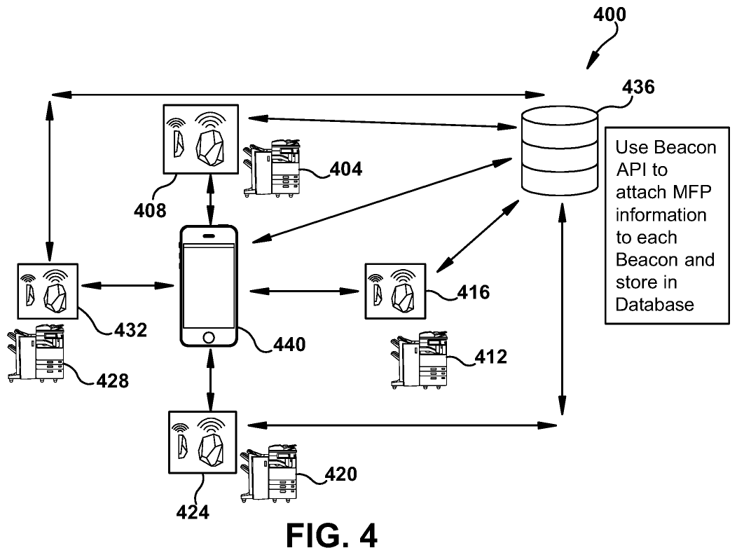

FIG. 4 illustrates an example embodiment of an MFP location system 400. Example MFPs include MFP 404 physically associated with beacon 408, MFP 412 physically associated with beacon 416, MFP 420 physically associated with beacon 424 and MFP 428 physically associated with beacon 432. Beacons may be standalone devices proximate to their associated MFP, or may be built in to each MFP. An MFP Bluetooth interface may itself serve as a beacon. It will be appreciated that any suitable number of MFPs may be subject to position location. In the illustrated example, MFPs are discovered and a location is determined in accordance with cross referencing beacon information with information stored in database 436, which may include device location and device capability information for MFPs associated with each beacon. This location information is shared with a user's portable data device such as illustrated smartphone 440.

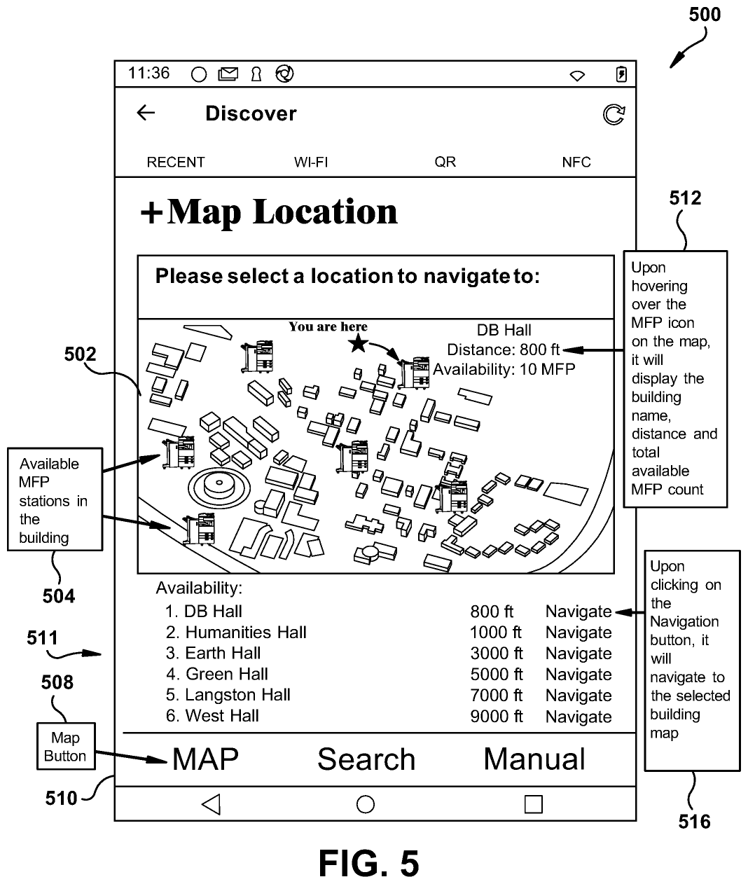

FIG. 5 illustrates an example embodiment of an MFP device discovery touchscreen interface 500 of a portable data device, such as a smartphone 440 of FIG. 4. The interface includes map illustration 502 showing available MFPs in various buildings, such as the examples illustrated with box 504. This interface is suitably called by selection of a map button 508 on a menu bar 510. A listing of buildings with MFP availability is rendered at 511. As illustrated by block 512, hovering a finger over an MFP icon on the map suitably displays a building name, distance from the user and available MFP information. The user suitably selects a building as illustrated by block 516. Upon selection, the user is navigated to the selected building and an available MFP inside the selected building.

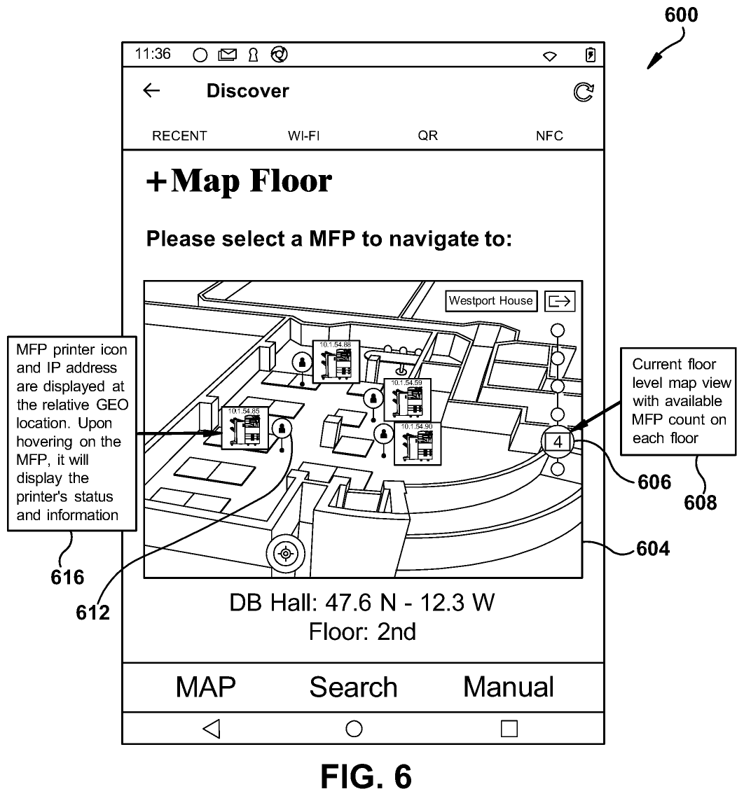

FIG. 6 illustrates an example embodiment of a user device interface 600, suitably generated when the user navigates to and enters their selected building. Once inside, the user may select a floor for an MFP when two or more floors have devices located on them. Depending on the floor the user selects, the interface suitably shows an overview of the available MFPs along an illustrated visual floorplan 604. Available MFPs on the floor are listed with icons, such as icon 606 identified by box 608. Example MFP icon 612, shown with an identifying IP address, shows relative device location. As noted in block 616, if a user hovers their touch over an MFP icon, it suitably displays printer information, such as printer status, which may include device capabilities, consumable levels, printing costs, and any other suitable device information. At each location, the interface provides a floating MFP icon and, upon clicking on the MFP icon, an image is generated to allow the user to see the MFP status, capabilities, IP address, device name or the like. MFP selection is made, suitably by double clicking the associated MFP icon, and inside navigation to the selected device commences.

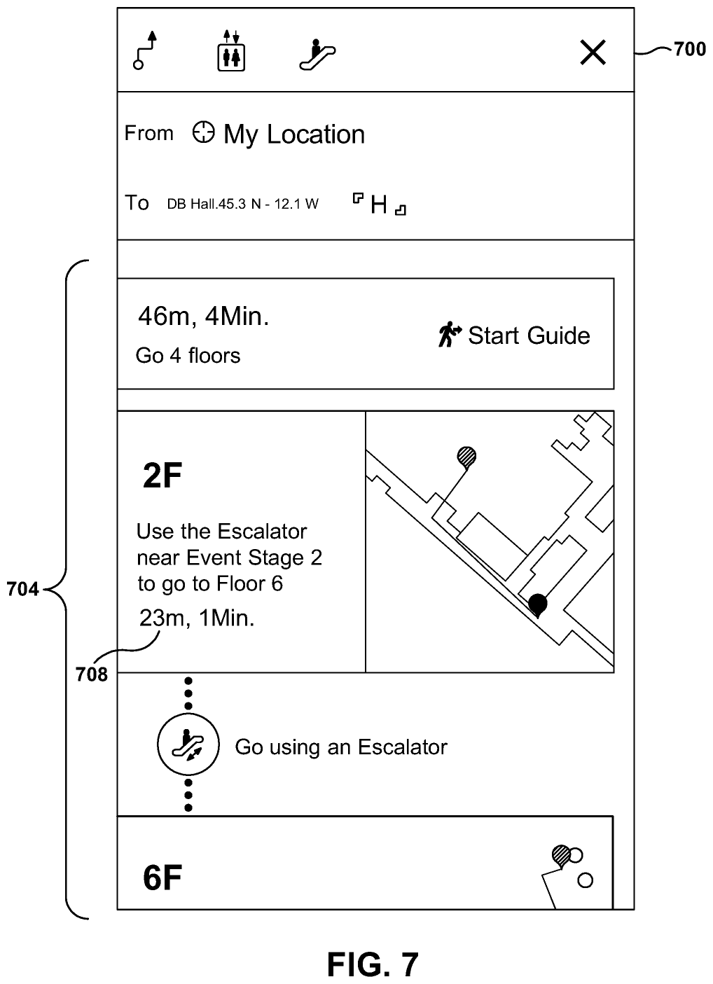

FIG. 7 illustrates an example embodiment of a user device interface screen 700. The interface shows a routing overview 704 and time estimation 708 from the user's current location to the selected location. Thus, the user is suitably provided with floor and elevation detail of the available MFPs.

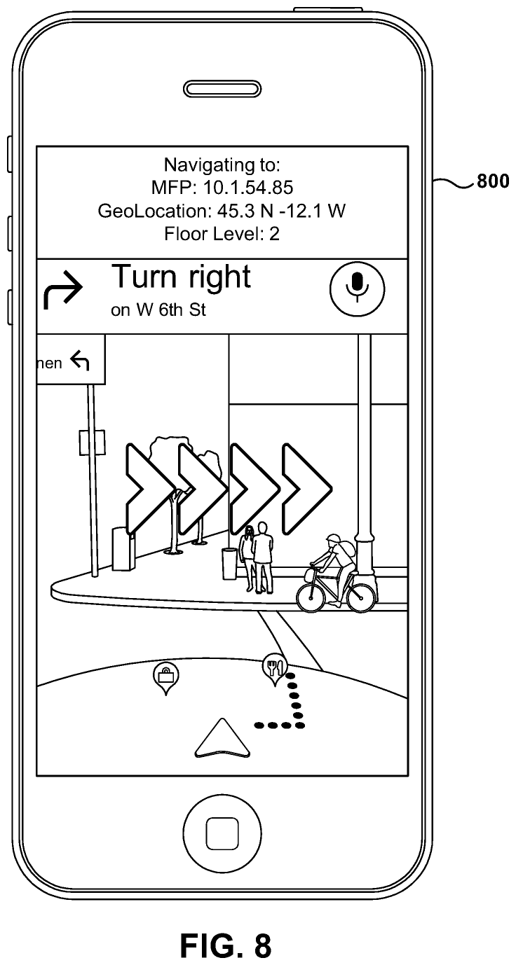

FIG. 8 is an example embodiment of a device interface 800 showing a suitable outdoor navigation view. As noted above, this is suitably accomplished by an application such as using the Google Map augmented reality SDK. This is facilitated when a user is outside of any building where it is possible to receive a GPS signal. Such an interface suitably provides three dimensional user navigation.

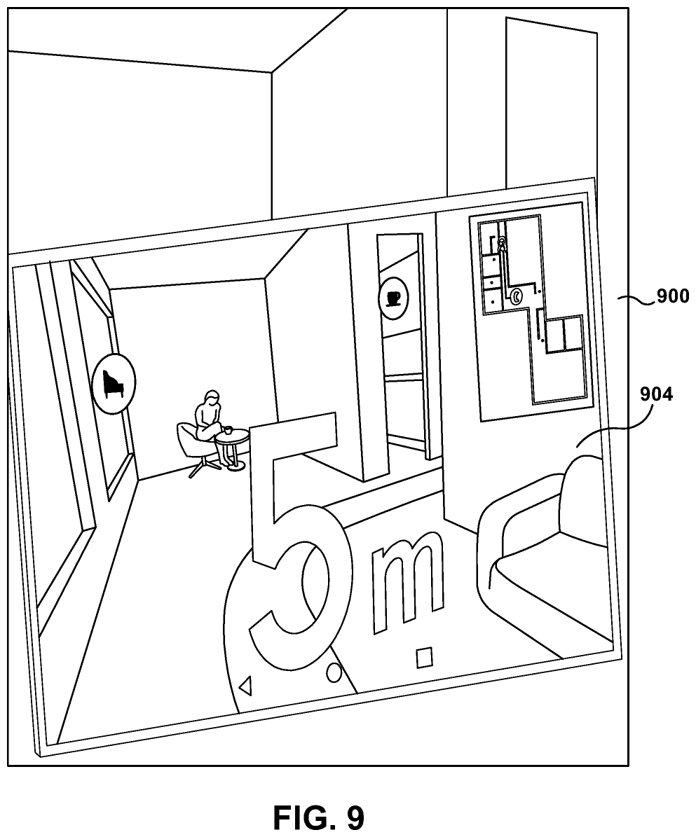

FIG. 9 is an example embodiment of a use environment 900 of an indoor navigation view or user device/interface 904. When the user is within an equipped building, beacon information functions to triangulate relative MFP location. When a building footprint is properly configured, the application provides the user with three dimensional navigation, such as including stair and escalator routing to the selected MFP.

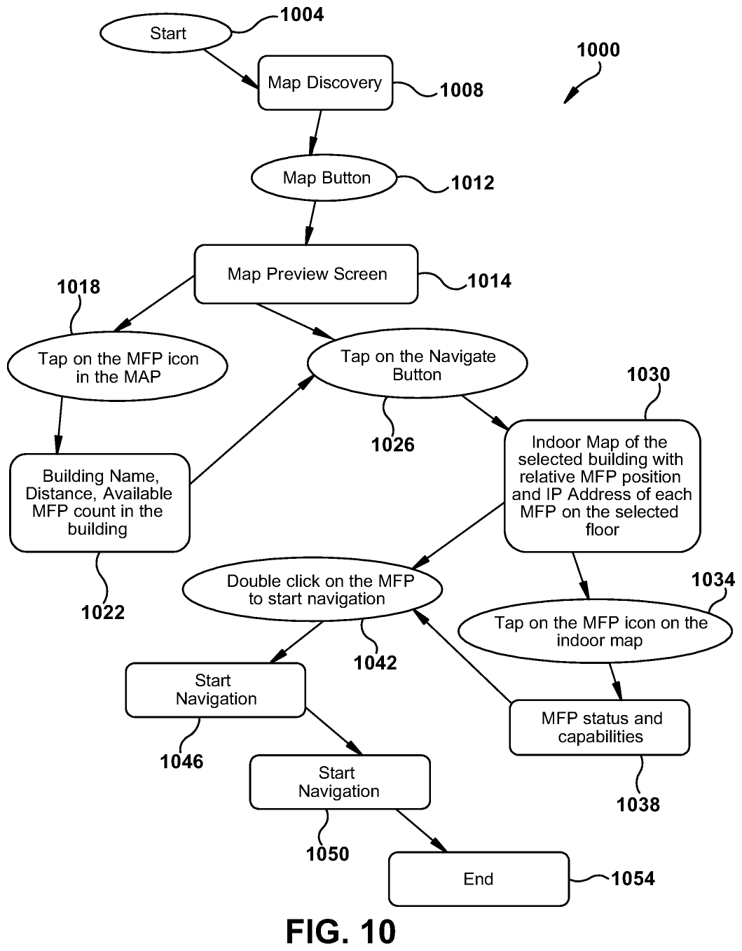

FIG. 10 is a flowchart 1000 of an example embodiment of an augmented reality system for mobile device discovery with indoor and outdoor navigation. The process commences at block 1004, and proceeds to block 1008 where MFP devices are discovered and mapped. Next, a user selects a map function at block 1012 and a map preview screen is generated at block 1014. When a user taps an MFP icon at block 1018, device information is displayed, such as building name, distance, available MFP count, and the like, at block 1022. If the user taps a navigate button at block 1026, navigation is commenced directly from the map preview screen. Alternatively, map navigation may be selected after display of device information at block 1022.

Once navigation is commenced at block 1026, an indoor map of a selected building with relative MFP position and IP address of MFPs on a selected floor is displayed at block 1030. From there, a user may double click a selected MFP icon at block 1042 to start navigation. Next, outdoor navigation is commenced at block 1046, followed by indoor navigation at block 1050. From block 1030, the user may also tap an MFP icon at block 1034 to display its associated MFP status and capabilities at block 1038, prior to commencing navigation at block 1042. Once indoor navigation is completed at block 1050, the process suitably ends at block 1054.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a memory;
a touchscreen user interface;
a wireless data interface; and
a processor,
the processor configured to generate a map display on the touchscreen including indicia illustrating a position of each of a plurality of MFPs on an associated premises,
the processor further configured to receive a user selection of an indicia via the touchscreen,
the processor further configured to display data corresponding to a status of a selected MFP associated with a user selected indicia,
the processor further configured to receive a second user selection associated with the user selected indicia via the touchscreen, and
the processor further configured to display navigation data corresponding to navigation to the selected MFP.

2. The system of claim 1 wherein the map display includes a display of a plurality of buildings housing the plurality of MFPs.

3. The system of claim 1 wherein the map display include a display of an interior of a building housing the selected MFP.

4. The system of claim 3 wherein the map display further includes indicia indicative of a floor level associated with each MFP.

5. The system of claim 1 wherein the status data includes document processing capabilities of the selected MFP.

6. The system of claim 1 wherein the navigation data includes an estimated travel time to the selected MFP.

7. The system of claim 6 wherein the navigation data further includes visual navigation directions to the selected MFP.

8. A method comprising:
storing position data corresponding to a position of each of a plurality of MFPs about a premises;
determining a position of a portable user device relative to the premises;
generating a touchscreen display map of the premises including indicia corresponding to each of the MFPs;
receiving a first user selection of an indicia;
displaying status data corresponding to a status of an MFP associated with a user selected indicia;
receiving a second user selection of the user selected indicia;
determining a relative position of the portable user device relative to the MFP associated with the user selected indicia in accordance with the second received user selection; and
displaying navigation data corresponding to navigation of the portable data device to a user selected MFP associated with the second user selection.

9. The method of claim 8 further comprising generating the position data in accordance with sensing beacons associated with each MFP.

10. The method of claim 8 further comprising displaying the map of the premises including a display of a plurality of buildings proximate to the portable data device, each of the buildings associated with one or more of the MFPs.

11. The method of claim 10 wherein the display of buildings proximate to the portable data device is generated in accordance with global positioning data.

12. The method of claim 10 further comprising:
receiving a user selection of a building from the plurality of displayed buildings; and
displaying the map including a display of a floorplan of one or more floors of a user selected building along with indicia corresponding to MFP locations relative to the location of the portable data device.

13. The method of claim 12 wherein the display of the floorplan relative to the location of the portable data device is determined in accordance with Wi-Fi positioning.

14. The method of claim 8 further comprising displaying the status data including data corresponding to document processing capabilities of the MFP associated with the user selected indicia.

15. The method of claim 8 further comprising displaying the navigation data including an estimated time to get to the user selected MFP.

16. A system comprising:
memory storing status data corresponding to a status of each of a plurality of MFPs;
a data interface; and
a processor,
the processor configured to receiving beacon data corresponding to beacons broadcast by each of a plurality of MFPs,
the processor further configured to generate a location map of the MFPs relative to a premises in accordance with received beacon data,
the processor further configured to receive location data corresponding to a location of a portable data device,
the processor further configured to output map data indicative of MFPs relative to received location data,
the processor further configured to receive selection data corresponding to an MFP selected from the map data,
the processor further configured to output status data corresponding to a status of a selected MFP to the portable data device,
the processor further configured to generate the location map including indicia of the selected MFP relative to the portable data device, and
the processor further configured to generate a time estimate to reach the selected MFP in accordance with the location of the portable data device.

17. The system of claim 16 wherein the location data is associated with global positioning data and Wi-Fi location data.

18. The system of claim 16 wherein the location map includes a map of a plurality of buildings of the premises.

19. The system of claim 18 wherein the location map includes a map of one or more floors of a selected building of the premises.

20. The system of claim 19 wherein the processor is further configured to generate progressive travel instructions for movement of the portable data device to the selected MFP.
